(19) United States
(12) Patent Application Publication
(10) Pub. No.: US 2024/0406844 A1
(43) Pub. Date: Dec. 5, 2024

(54) CONFIGURING A COMMUNICATION DEVICE

(71) Applicant: Nokia Technologies Oy, Espoo (FI)

(72) Inventors: Athul PRASAD, Naperville, IL (US); David BHATOOLAUL, Swindon (GB); Naizheng ZHENG, Beijing (CN); David NAVRATIL, Espoo (FI); Ugur Baran ELMALI, Munich (DE)

(21) Appl. No.: 18/695,652

(22) PCT Filed: Sep. 29, 2021
(86) PCT No.: PCT/CN2021/121732

§ 371 Date: Mar. 26, 2024

(51) Int. Cl. H04W 48/08; H04L 5/00; H04W 72/30

(52) U.S. Cl. CPC H04W 48/08; H04L 5/0053; H04W 72/30

(57) ABSTRACT

Methods and apparatus for multicast services are provided. In a method a resource message is received on a control channel indicating a first search space type and assistance information for the first search space type. It is determined based on the assistance information that a second search space type is to be applied for monitoring of a multicast search space. Monitoring of the multicast search space can be provided according to the second search space type.

### FIELD

The present disclosure relates to methods, apparatuses and computer program products for configuring a communication device for multicasting in a communication system.

### BACKGROUND

Data can be communicated between communication devices such as user or terminal devices, base stations/access points and/or other nodes. Communication may be provided, for example, by means of a communication network and one or more compatible communication devices. A communication device at a network side provides an access point to the system and is provided with an appropriate signal receiving and transmitting apparatus for enabling communications, for example enabling other devices to access the communication system. Communication may comprise, for example, communication of data for carrying communications such as voice, video, electronic mail (email), text message, multimedia and/or content data and so on. Non-limiting examples of services provided comprise two-way or multi-way calls, data communication, multimedia services and access to a data network system, such as the Internet. It is also possible to multicast/broadcast data to communication devices.

In a mobile or wireless communication system at least a part of data communication between at least two devices occurs over a wireless or radio link. Examples of wireless systems comprise public land mobile networks (PLMN), satellite-based communication systems and different wireless local networks, for example wireless local area networks (WLAN). The wider communication system by means of an appropriate communication device or terminal. Such a device may be referred to as user equipment (UE).

A communication device is provided with an appropriate signal receiving and transmitting apparatus for enabling communications, for example enabling access to a communication network or communications directly with other users. A communication device of a user may receive signalling by a station at a radio access network, for example a base station, and transmit and/or receive communications accordingly.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called fifth generation (5G) or New Radio (NR) networks. 5G is being standardized by the 3rd Generation Partnership Project (3GPP).

Multicast Broadcast Service (MBS) is a point-to-multipoint communication scheme where unlike in unicast services data can be transmitted simultaneously from a single source to multiple destinations/devices. Broadcast refers to the ability to deliver content to all users. Multicast refers to distribution of content for services among a specific group of devices or users that are subscribed to those services.

### SUMMARY

In accordance with an aspect there is provided a method in a communication device, comprising: receiving on a control channel a resource message indicating a first search space type and assistance information for the first search space type, determining based on the assistance information that a second search space type is to be applied for monitoring of a multicast search space, and monitoring the multicast search space according to the second search space type.

According to an aspect there is provided a method of configuring a communication device, comprising: sending to the communication device on a control message for configuring radio resource reception, the message indicating a first search space type and assistance information for the first search space type for enabling the communication device to determine that a second search space type is to be applied for monitoring of a multicast search space, and multicasting data to the communication device on the radio resource.

According to yet another aspect there is provided method in a communication device, the method comprising receiving on a control channel multicast-broadcast service configuration message, determining that the message indicates a monitoring priority rule indicative of a certain search space type, and selecting a different type of the monitoring priority to be applied based on determining whether at least one of downlink control information formats defined for group-common physical downlink control channel is configured.

According to an aspect there is provided apparatus for a communication device, the apparatus comprising at least one processor and at least one memory including a computer program code, the at least one memory and computer program code configured to, with the at least one processor, cause the apparatus at least to:
receive on a control channel a resource message indicating a first search space type and assistance information for the first search space type,
determine based on the assistance information that a second search space type is to be applied for monitoring of a multicast search space, and
monitor the multicast search space according to the second search space type.

According to an aspect there is provided apparatus for a communication network, the apparatus comprising at least one processor and at least one memory including a computer program code, the at least one memory and computer program code configured to, with the at least one processor, cause the apparatus at least to:
send to the communication device on a control message for configuring radio resource reception, the message indicating a first search space type and assistance information for the first search space type for enabling the communication device to determine that a second search space type is to be applied for monitoring of a multicast search space, and
multicast data to the communication device on the radio resource.

According to yet another aspect there is provided apparatus for a communication device comprising at least one processor and at least one memory including a computer program code, the at least one memory and computer program code configured to, with the at least one processor, cause the apparatus at least to: receive on a control channel multicast-broadcast service configuration message, determine that the message indicates a monitoring priority rule indicative of a certain search space type, and select a different type of the monitoring priority to be applied based on determining whether at least one of downlink control information formats defined for group-common physical downlink control channel is configured.

According to a more specific aspect the first search space type comprises a common search space type-3. The second search space type may comprise a common search space type for scheduling multicast/broadcast service.

A resource message may indicate the first search space type explicitly and the second search space type implicitly.

The second search space type can be used to indicate monitoring priority.

A communication device may determine the second search space type based on information of resources associated with a common search space set within a common frequency region and search space set indexes.

A resource message may comprise a radio resource control message including information of control resource set resources associated with a common search space set.

A communication device can determine that monitoring is to be based on the second search space type in response to determining that control resource set resources associated with a common search space set are fully contained within a common frequency region and downlink control information format associated with the common search space set includes at least one of downlink control information formats defined for group-common physical downlink control channel.

The downlink control information format may comprise formats that are defined for scheduling multicast and/or broadcast traffic. The downlink control information format may comprise formats 1_0 and/or 1_1.

A communication device may determine whether search space index reservation has been configured.

A resource message may comprises a pdcch-config message or a pdcch-config-mbs message. A communication device receiving a pdcch-config-mbs message may determine that the message indicates a monitoring priority rule indicative of application of a certain type, and then selecting the type of the monitoring priority rule based on determining whether at least one of downlink control information formats defined for group-common physical downlink control channel is configured.

Means for implementing the herein disclosed operations and functions can also be provided. The means can comprise appropriately configured hardware and software.

A computer software product embodying at least a part of the herein described functions may also be provided. In accordance with an aspect a computer program comprises instructions for performing at least one of the methods described herein.

### BRIEF DESCRIPTION OF DRAWINGS

Some aspects will now be described in further detail, by way of example only, with reference to the following examples and accompanying drawings, in which:

FIG. 1 illustrates an example of a system where the invention can be practiced;

FIG. 2 shows an example of a control apparatus;

FIGS. 3 to 9 are flowcharts according to certain examples; and

FIG. 10 shows examples for indicating priority rules.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communication systems provide wireless communications to devices connected therein. Typically, an access point such as a base station is provided for enabling the communications. In the following, different scenarios will be described using, as an example of an access architecture, a 3GPP 5G radio architecture. However, embodiments are not necessarily limited to such an architecture. Some examples of options for suitable systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof.

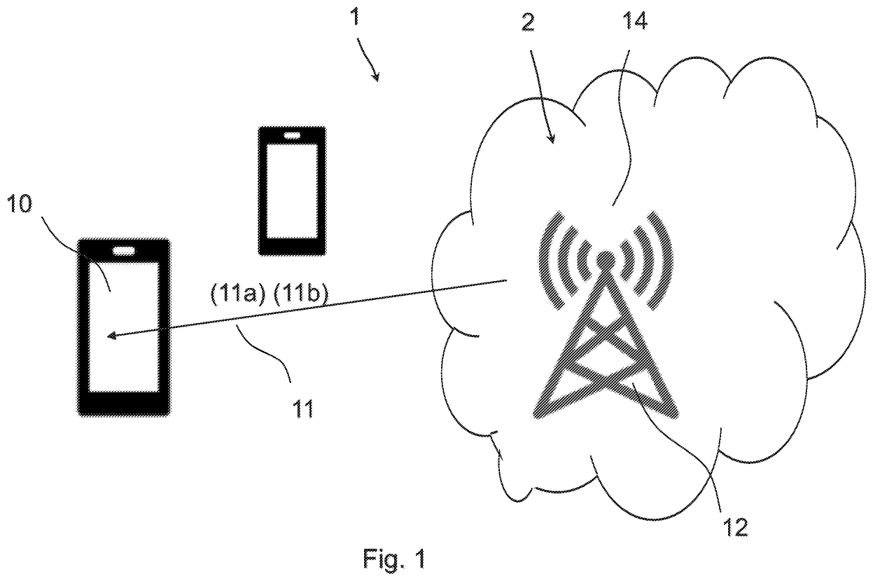

FIG. 1 shows a wireless system 1 comprising a radio access system or radio access network (RAN) 2. A radio access system can comprise one or a plurality of access points, or base stations 12. A base station may provide one or more cells. An access point can comprise any node that can transmit/receive radio signals (e.g., a TRP, a 3GPP 5G base station such as gNB, eNB, a user device and so forth). A number of radio access systems can be provided in a communication system.

Communication devices 10 can be located in the service area of the radio access system 2. For simplicity, only a couple of devices are shown, and the following description explains the operation in relation to one of the devices. Device 10 can listen to the access point 12. Communications from the device 10 to the access point 12 is commonly referred to as uplink (UL). Communications from the access point 12 to the device 10 is commonly referred to as downlink (DL).

It is noted that the wider communication system is only shown as cloud 2 and can comprise a number of elements which are not shown for clarity. For example, operation in accordance with a 5G based system may be comprised in a terminal or user equipment (UE), a 5G radio access network (5GRAN) or next generation radio access network (NG-RAN), a 5G core network (5GC), one or more application function (AF) and one or more data networks (DN). The 5G-RAN may comprise one or more gNodeB (gNB) or one or more gNodeB distributed unit functions connected to one or more gNodeB centralized unit functions. The 5GC may also comprise entities such as Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); Session Management Function (SMF) and so on.

The communication device 10 may be any suitable device adapted for wireless communications. A wireless communication device may be provided by any device capable of sending and receiving radio signals. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices, a Cellular Internet of things (CIoT) device or any combinations of these or the like. The device may be provided as part of another device. The device may receive signals over an air or radio interface via appropriate apparatus for receiving and may transmit signals via appropriate apparatus for transmitting radio signals. The communications can occur via multiple paths. To enable MIMO type communications devices may be provided with multiantenna elements.

FIG. 1 denoted further by arrow 11 downlink signalling according to certain examples. The signalling can comprise (11a) higher layer configurations for search space sets and (11b) assistance information for determining monitoring priorities of configured search space sets.

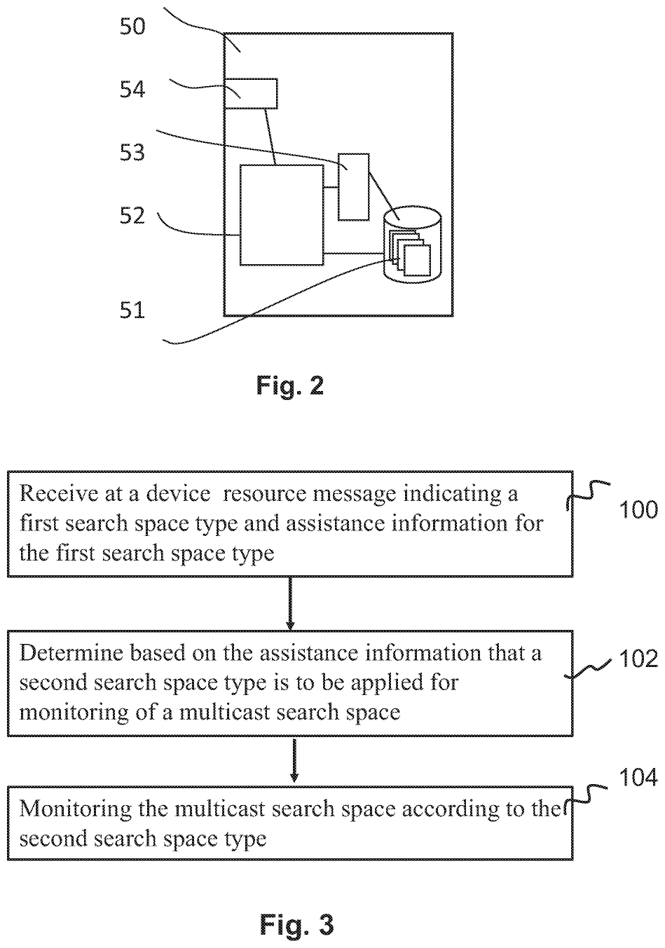

A communications device such as the access point 12 or the device 10 is provided with data processing apparatus comprising at least one processor and at least one memory. FIG. 2 shows an example of a data processing apparatus 50 comprising processor(s) 52, 53 and memory or memories 51. FIG. 2 further shows connections between the elements of the apparatus and an interface for connecting the data processing apparatus to other components of the device.

The at least one memory may comprise at least one ROM and/or at least one RAM. The communications device may comprise other possible components for use in software and hardware aided execution of tasks it is designed to perform, including control of access to and communications with access systems and other communications devices, and implementing the herein described features of the device in relation to multicast/broadcast (MBS) services. The at least one processor can be coupled to the at least one memory. The at least one processor may be configured to execute an appropriate software code to implement one or more of the following aspects. The software code may be stored in the at least one memory, for example in the at least one ROM.

The following describes certain aspects, configurations and signaling for multicast/broadcast related operations using 5G terminology. Multicast Broadcast Service (MBS) is a feature of mobile communication systems. MBS is a point-to-multipoint communication scheme where data can be transmitted simultaneously from a single source to multiple destinations/devices. Broadcast refers to the ability to deliver content to all users. Multicast refers to distribution of content for services among a specific group of devices or users that are subscribed to those services. The multicast and broadcast content may be transmitted over a geographical area referred to as a zone. An MBS zone is a collection of one or more network access nodes (e.g., base stations) that are capable of transmitting the same content.

3GPP 5G/NR multicast standardisation is currently working on delivery mechanisms of multicast/broadcast traffic to a multitude of receiving devices (UEs). An aim is to define group scheduling mechanisms that enable the multicast/broadcast traffic to be scheduled using common data channel resources while maintaining maximum commonalities with the already defined unicast scheduling and operation mechanisms. Use of common data channel resources for scheduling multicast/broadcast service (MBS) downlink data can be problematic, especially because of different search space (SS) types which have different monitoring priorities. In Radio Resource Control (RRC) connected mode the currently relevant search space (SS) types are type-3 common SS (type-3 CSS) and UE-specific SS (USS). Currently, Type-3 CSS would always have priority over USS type. A monitoring priority rule/option is needed wherein the SS set for multicast may have a lower priority than type-3 CSS and configurable priority (above/lower/within) when compared to USS. Monitoring priority may applied in case of overbooking—for example if an UE is configured with a larger number of SS sets/PDCCH candidates than it is capable of monitoring, the UE may need to prioritize the search spaces so that it may monitor only the high-priority search spaces.

In accordance with the current state of 5G, type-3 Physical Downlink Control Channel (PDCCH)/search space (SS) sets with setting ‘type=common’ and configured using Radio Resource Control (RRC) after connection establishment is used for configuring Common Search Space (CSS) sets and ‘type=UE-specific’ for UE-specific Search Space (USS) sets. Multicast is applicable only to UEs in connected mode and therefore only type-3 is applicable in that scenario. Thus UE-specific Search Space (USS) and type-3 CSS can be configured only after establishing the RRC connection. Based on the RRC configurations, the UE and gNB map Physical Downlink Control Channel (PDCCH) candidates in each slot with: (i) CSS sets mapped before USS sets, (ii) USS sets are mapped in ascending order of the SS set indices, and if the number of PDCCH candidates/CCEs exceeds either of the UE processing limits, then (iii) no more SS sets are mapped in the slot after reaching the UE processing limit. These rules allow base station (BS) to number SS sets of a connected UE according to desired priority.

The currently defined mechanisms cannot be reused for other types because of a monitoring priority rule where the SS set for multicast can have a lower priority than CSS and configurable priority within the USS. It has been agreed that the monitoring priority for the SS sets used to schedule multicast traffic is to be configurable to have value of above, below or within the USS sets. This CSS set is called multicast search space (MSS), with flexible prioritization between CSS and USS based on SS indexes, and otherwise with the same characteristics as the CSS. In short, this type of CSS can be called type-x CSS. The type-x CSS monitoring priority can be applied, e.g., in the case of overbooking. That is, if a UE is configured with a larger number of PDCCH candidates than it is capable of monitoring, the UE can prioritize the search spaces so that it can monitor only high-priority search spaces and can ignore the lower priority search spaces in case the UE is not capable of monitoring them.

Downlink Control Information (DCI) is carried on the PDCCH. In general, the DCI may be used to indicate resource assignment in uplink or downlink for one Radio Network Temporary Identifier (RNTI). As an extension to this, a control resource set (CORESET) generally refers to a time and frequency allocation for the PDCCH and is generalised to a set of resource blocks and symbols. A DCI can thus convey various pieces of information. The useful content of DCI can depend on the specific case of system deployment or operations. Downlink control information (DCI) formats based on currently defined Cell-Radio Network Temporary Identity (C-RNTI) formats 1_0 and 1_1 can be used by the gNB as a baseline to inform a UE about the group-common Physical Downlink Shared Channel (PDSCH) resources where multicast/broadcast downlink data would be scheduled. Currently these formats have been defined only for unicast traffic, which implies that the access node (gNB in 5G) can utilize one of these DCI formats to inform the UE about upcoming scheduled downlink information over PDSCH using UE-specific PDCCH. DCI formats 1_0 and 1_1 can thus be used for scheduling multicast traffic PDSCH resources, with the CRC scrambled using a group-common/G-RNTI. As explained in more detail below, DCI format 1_1 can be configured in type-x CSS for UEs receiving multicast traffic.

The SS sets can be configured using pdcch-config message. For MBS a gNB can optionally configure a UE with a RRC configuration message pdcch-config-mbs including the SS sets. This is an optional configuration and the gNB can still reuse the existing pdcch-config for configuring MBS related SS set parameters, depending on the gNB implementation.

Multicast/broadcast traffic can be scheduled within a common frequency region (CFR) within the UE active bandwidth part (BWP). The common frequency region (CFR) configurations—including the starting physical resource block (PRB) and size would be signalled to the UE via RRC. Thus all UEs within the zone can be made aware of the common frequency region (CFR) where the multicast traffic is to be scheduled. CSS for multicast can have different priority than CSS for unicast. However, it is open how the UE would know that the configured CSS is for unicast or multicast.

A specific monitoring priority—which is different from the currently defined monitoring priorities (called “type-x” in this specification)—is needed. However, there is no explicit agreed definition of type-x CSS and mechanism for signalling the type. This means that there is no definition how “type-x” could be explicitly signalled to receiving devices such as UEs as a part of RRC configuration. “Type-x” necessitates a different monitoring priority from the “type-3” monitoring priority, even though “type-x” is part of type-3 CSS from RRC configuration viewpoint. However, the UEs cannot be informed of the search space configuration type via explicit signalling for the SS type-x, meaning that the UE is not aware whether the currently defined monitoring priority for CSS (type-3) should be applied or whether the monitoring priority of type-x CSS which is dependent on the SS set index should be applied.

According to a possible approach to address this the network can inform implicitly a UE that a configured search space is supposed to be a CSS for MBS (i.e., type-x CSS) instead of another type. Prioritization for blind decoding attempts can then be performed by the UE without need to explicitly define a new CSS type for the RRC signalling. According to a possibility information of different criteria is combined to implicitly indicate that the type is type-x CSS. A possibility for avoiding signalling a SS configuration which explicitly includes a configured CSS type and an index, another type configuration (type-3) is signalled, and the receiver device (UE) is separately informed that the signalled index means that the monitoring priority of another type (in this example type-x) should be used instead.

The flowchart of FIG. 3 shows a general example for possible process in a communication device. In the method the communication device receives at 100 on a control channel a resource message indicating a first search space type and assistance information for the first search space type. The device then determines at 102, based on the assistance information, that a second search space type is to be applied for monitoring of a multicast search space instead of the first type. The device then applies the second search space type at 104 for monitoring of the multicast search space.

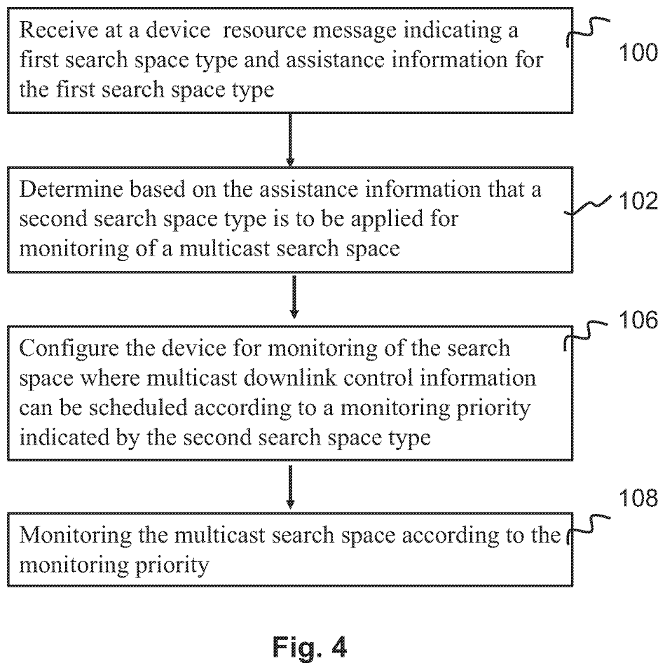

FIG. 4 illustrates a more detailed example where the first two step 100 and 102 are as above. The device is configured at 106 for monitoring of the search space where multicast downlink control information can be scheduled according to a monitoring priority indicated by the second search space type. The device monitors at 108 the search space according to the monitoring priority of the second search space type.

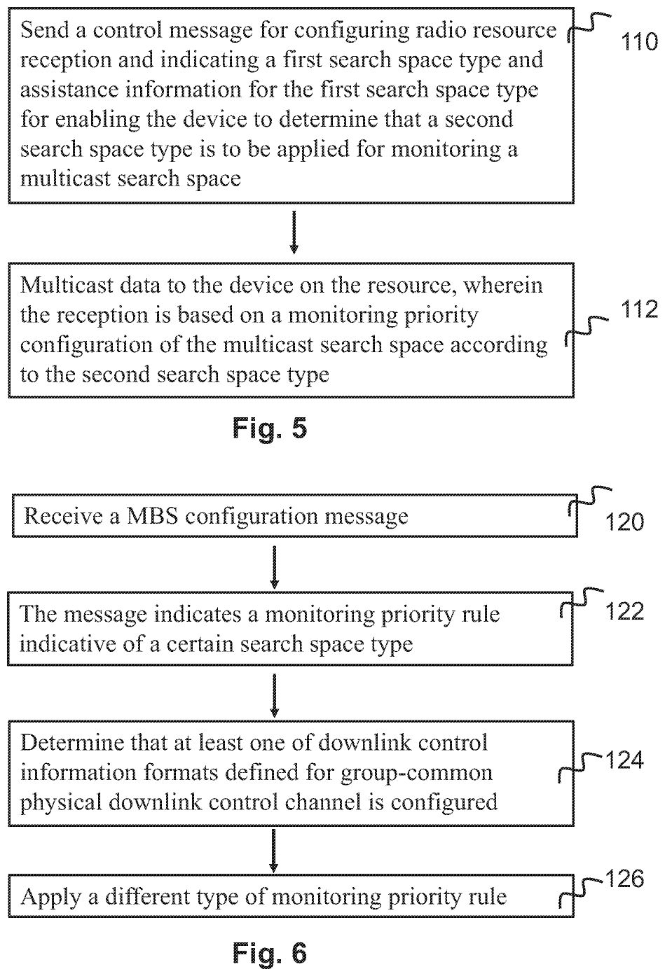

FIG. 5 illustrates a possible operation at the network side in the node sending the signalling for configuring a communication device. The method comprises sending at 110 to the communication device on a control channel a resource message indicating a first search space type and assistance information for a common search space, wherein the assistance information comprises information enabling the communication device to determine based on the assistance information that a second search space type is to be configured for monitoring of a multicast search space. Data is multicast at 112 by the node to the device on the resource, wherein the reception by the device is based on a monitoring priority configuration of the multicast search space according to the second search space type and the assistance information.

FIG. 6 illustrates a yet another possible operation at the receiving device side. The device can receive at 120 a multicast-broadcast service configuration message. Determination is made at 122 that the message indicates a monitoring priority rule indicative of a certain search space type. A different type of the monitoring priority to be applied can be selected at 126 based on determining at 124 whether at least one of downlink control information formats defined for group-common physical downlink control channel is configured.

The first search space type may comprise a common search space type-3. The second search space type may comprise a common search space type for multicast/broadcast service (type-x).

More detailed examples will now be explained in the following. A communication device referred to as a UE can be configured with a search space set, using existing RRC specifications, even in the absence of any explicit definition of a new search space type for the type-x CSS. The UE is configured to interpret whether the defined monitoring priority for CSS should be applied or whether the monitoring priority of type-x CSS which is dependent on the SS set index/ID should be applied. To provide differentiated priority existing signalling of ‘SS type=common’ can be used and no new explicit SS type definition is needed yet enabling the UE to apply the differentiated priority.

The detailed examples reuse the currently defined search space RRC configurations to indicate to the UE whether to apply type-3 PDCCH based monitoring priority or type-x PDCCH based monitoring priority without explicitly defining a new search space type. In the examples the cost of explicit signalling may be avoided or at least reduced, the cost being related to additional higher layer signalling-if UE has both G-RNTI and C-RNTI based DCI configured there needs to be two separate RRC configurations provided. Explicitly signalling that type-x should be applied would cause additional overhead, and reuse of current signalling as much as possible and enable the UE to determine how to apply the differentiated priority can be used to avoid that.

A user equipment can apply differentiated monitoring prioritization for a search space set where the downlink control information of multicast/broadcast traffic would be scheduled, with assistance information from the network. Different mechanisms for determination of the monitoring prioritization for a search space can be configured to the UE. In accordance with an example a UE can assume that type-3 CSS configured using the pdcch-config message is a type-x CSS/MSS if two conditions are met: the CORESET resources associated with the SS set is fully contained within the (MBS) CFR and the DCI format associated with the CSS set includes formats defined for group-common PDCCH. Examples of these are the already mentioned DCI formats 1_0 and/or 1_1. The UE would then apply the new monitoring priority based on the SS index of the SS set, with flexible prioritization between CSS and USS, irrespective of the configured SS set type. Otherwise, the UE would apply the conventional priority rules. That is, if DCI formats 1_0 and/or 1_1 is not configured, the UE can assume that the search space set is a type-3 CSS, with higher monitoring priority than USS, irrespective of the SS index/ID.

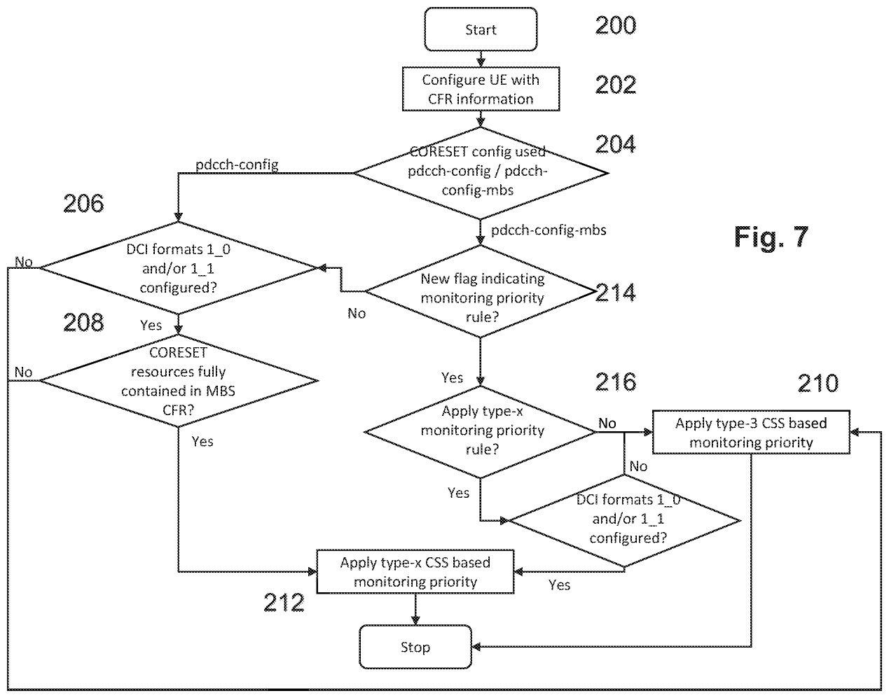

The UE can be configured to interpret the CSS type based on configured DCI types. Detailed examples for implicitly indicating the type are shown in FIGS. 7-9. The gNB can configure SS type always as common but the UE can differentiate between type-x CSS and type-3 CSS based on analysis of assistance information. The assistance information may comprise one or more of the following: the location of CORESET resources in relation to MBS CFR, the RRC configuration type used (whether the message is pdcch-config or pdcch-config-mbs), or explicit SS index reservation.

An overview of an example method is shown in the flowchart of FIG. 7 where the prioritization determination can be based on pdcch-config/pdcch-config-mbs messages. The flowchart illustrates the operation from the UE perspective in terms of the logic that is applied after receiving the resource message for determining the monitoring priority of a given SS set. The gNB can use either or both pdcch-config and pdcch-config-mbs messages for configuring the search space sets and associated CORESETs, and therefore both options are considered.

It shall be appreciated that arrangements and operations where only one of the branches may be performed are possible. That is, the selection step 204 is not necessary in all applications, and only one of the messages may be used for the configuration. A receiving device/the program code thereof may be configured to perform only one of the branches.

Configuration is started at 200 and UE is configured with CFR information at 202. The UE can then determine at 204 whether the CORESET message was pdcch-config or pdcch-config-mbs message. If the gNB uses pdcch-config for configuring the type-x CSS, the UE needs to determine at 206 whether the group-common PDCCH formats (based on DCI formats 1_0/1_1) is configured within the SS set. If yes, then it is determined at 208 whether the associated CORESET resources are fully contained within the MBS CFR. The CORESET resources are contained within the MBS CFR in order to ensure that all UEs are monitoring the common resources where the DCI could be scheduled.

If no at 206 or 208, then the UE knows to apply type-3 CSS based monitoring priority at 210, and the decision process stops.

If both tests are positive, then type-x CSS based monitoring priority is applied at 212 and the decision process can stop.

If it is determined at 204 that the gNB uses pdcch-config-mbs for configuring the type-x CSS, the UE can determine at 214 whether a flag for applying the type-x monitoring priority is configured. If this flag is configured and since the pdcch-config-mbs is mainly targeting MBS related configurations, the UE can determine at 216 that type-x CSS monitoring priority rule is applied after checking at 218 whether the group-common PDCCH formats (based on DCI formats 1_0/1_1) is configured within the SS set.

If no at 216 or 218, then the UE knows to apply type-3 CSS based monitoring priority at 210, and the decision process stops.

If both tests are positive, then type-x CSS based monitoring priority is applied at 212 and the decision process can stop.

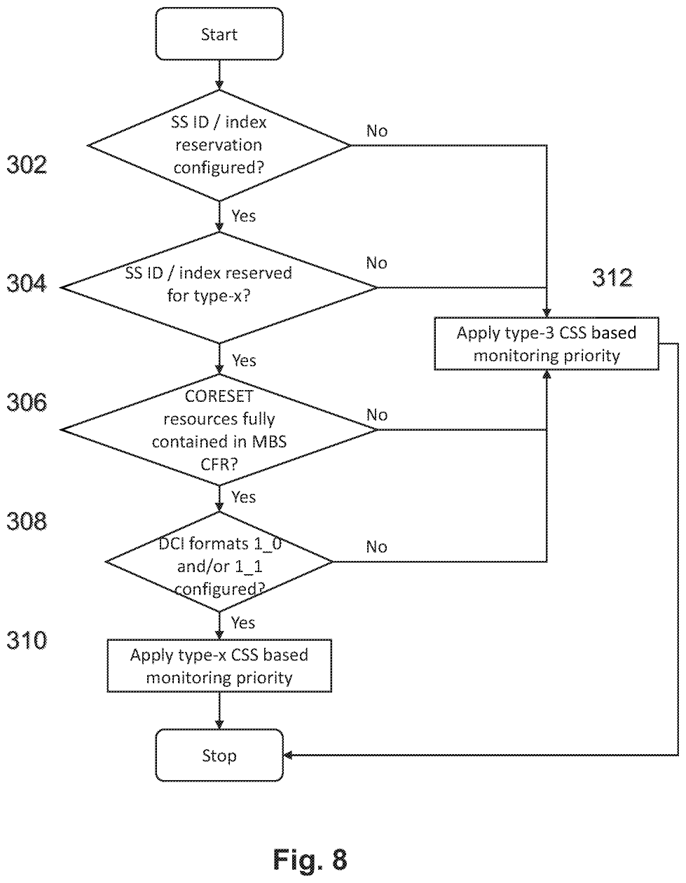

FIG. 8 shows a flowchart for operation that is based on search space (SS) index reservation. SS index reservation-based operation utilises the property of a gNB being able to configure/reserve SS index values for the CFR. These may be configured along with MBS CFR parameters using higher layer/RRC signalling, which can be treated as type-x CSS/MSS by UEs. Depending on the indexes reserved for type-x CSS, the gNB can apply monitoring prioritization relative to MSS and CSS. The UE can be informed whether higher priority search space type (type-3) is being configured or a search space type with different monitoring priority than type-3, i.e., type-x is being configured based on the SS index.

If the UE determines at 304 that the configuration for reserving certain SS indexes for type-x CSS is configured at 302 and it is further determined at 306 that group-common PDCCH is configured in the reserved SS sets and CORESET resources are fully contained within CFR, and at 308 that the DCI format are configured then the UE can apply the CSS type-x based monitoring priority at 310. If the test was negative in any of steps 302, 304, 306 or 308, then type-3 CSS based priority is applied at 312.

The gNB can thus configure the SS set using pdcch-config-mbs message. Since CORESET resources can be assumed to always be confined within the MBS CFR which can be configured separately using RRC, the UE needs to apply type-x CSS/MSS based monitoring priority, irrespective of the DCI format configured. Type-x priority is applied only when the DCI formats which could be used to schedule multicast is used.

Optionally, the gNB can send a new flag within the pdcch-config-mbs or other higher layer configuration signaling related to multicast/broadcast traffic, which indicates whether the SS set with type=common need to be considered as type-3 or type-x CSS.

In another example of prioritization determination based on SS index reservation the checks of steps 304, 306 and 308 can optionally be not considered at all and only SS index based reservation test of 302 is applied. It would then be up to gNB implementation to reserve SS indices only if the gNB actually plans to configure MBS DCI formats and actual DCIs containing information related to group-common PDCCHs, or if the gNB requires UE to apply the differentiated monitoring priority of type-x CSS.

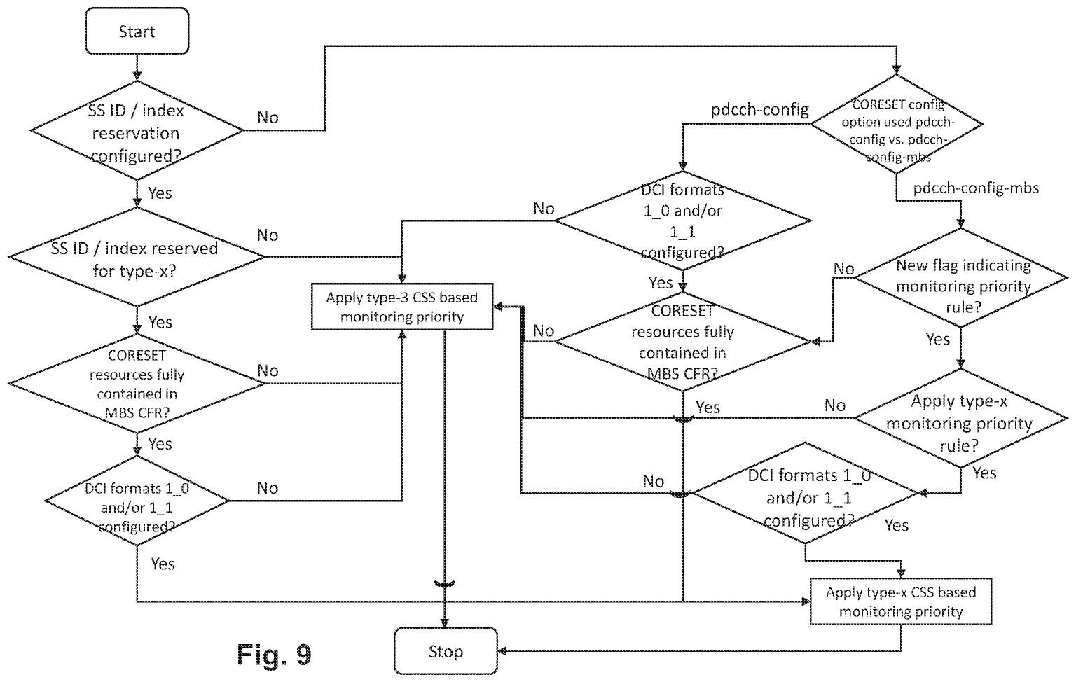

FIG. 9 shows a flowchart for a hybrid method combining various options to configure a UE. More particularly, prioritization determination based on a combined use of SS index reservation (shown in FIG. 8) and pdcch-config/pdcch-config-mbs methods (shown in FIG. 7) may be provided. The receiving device may be configured to follow each of the branches depending on the selections made.

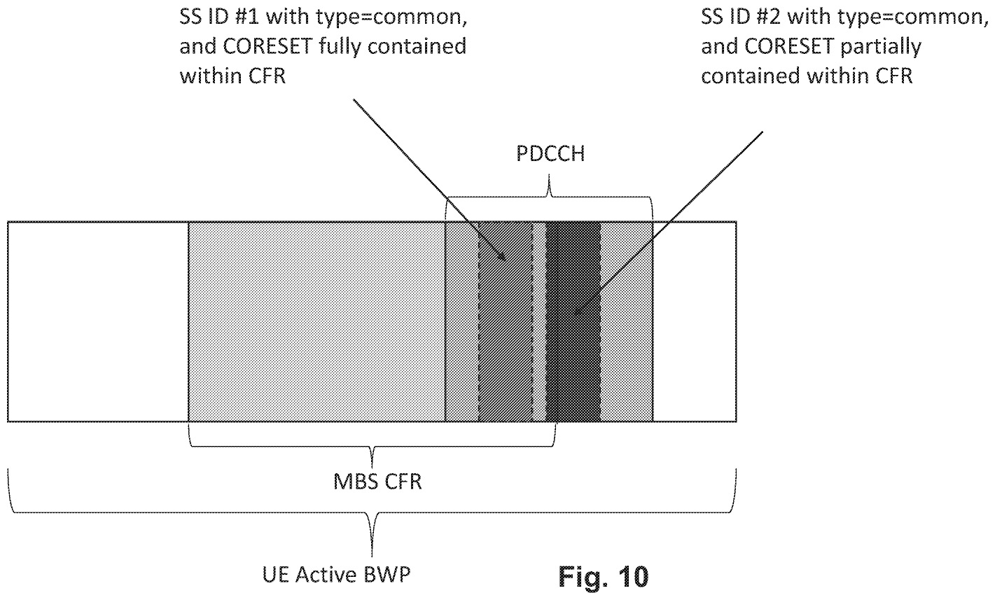

FIG. 10 shows an example of possible relation between UE active BWP, MBS CFR and common SS sets with different priority rules. In the possible configuration of UE active BWP frequency resources with MBS CFR resources contained within the active BWP and PDCCH resources for the active BWP a UE can determine SS ID #1 to be a type-x CSS if predefined conditions such as those shown in FIGS. 6-8 are met. This is so since the CORESET resources are fully contained within MBS CFR. However, SS ID #2 cannot be a type-x CSS, since the CORESET resources are not fully contained within the MBS CFR.

The above describes certain non-limiting examples where a UE can be configured for search space (SS) monitoring using radio resource control (RRC) message/signalling. If the SS consists of too many PDCCH candidates (“overbooking”), the UE applies monitoring of the PDCCH within the configured search space based on a monitoring priority of the applied search space, the applied priority being defined by the search type. In typical operation common search space (CSS) has priority over UE specific search space (USS) and within USS the prioritization is based on SS indexes. The multicast search space (MSS)/type-x can be used to provide a differentiated priority between the CSS and USS, based on the SS index. A gNB can transmit multicast data to the configured UEs. The ability of a UE to receive the multicast data depends on the priority of the search space and whether the UE is able to monitor the search space for DCI message containing the group-common PDSCH resources where the multicast data is scheduled.

It is noted that while the above describes example embodiments, there are several variations and modifications which may be made to the disclosed solution without departing from the scope of the present invention. Different features from different embodiments may be combined.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1-27. (canceled)

28. A method, comprising:
receiving on a control channel a resource message indicating a first search space type and assistance information for the first search space type,
determining based on the assistance information that a second search space type is to be applied for monitoring of a multicast search space, and
monitoring the multicast search space according to the second search space type.

29. A method, comprising:
sending to a communication device on a control channel a resource message for configuring radio resource reception, the resource message indicating a first search space type and assistance information for the first search space type for enabling the communication device to determine that a second search space type is to be applied for monitoring of a multicast search space, and
multicasting data to the communication device on the radio resource.

30. An apparatus, comprising at least one processor and at least one memory storing instructions that, when executed by the at least one processor, cause the apparatus at least to:
receive on a control channel a resource message indicating a first search space type and assistance information for the first search space type,
determine based on the assistance information that a second search space type is to be applied for monitoring of a multicast search space, and
monitor the multicast search space according to the second search space type.

31. The apparatus according to claim 30, wherein the first search space type comprises a common search space type-3 and the second search space type comprises a common search space type for scheduling multicast/broadcast service.

32. The apparatus according to claim 30, wherein the resource message indicates the first search space type explicitly and the second search space type implicitly.

33. The apparatus according to claim 30, wherein the second search space type indicates monitoring priority.

34. The apparatus according to claim 30, wherein the instructions, when executed by the at least one processor, cause the apparatus to determine the second search space type based on information of resources associated with a common search space set within a common frequency region and search space set indexes.

35. The apparatus according to claim 30, wherein the resource message comprises a radio resource control message including information of control resource set resources associated with a common search space set.

36. The apparatus according to claim 30, wherein the instructions, when executed by the at least one processor, cause the apparatus to determine that the monitoring is to be based on the second search space type in response to determination that resources of a control resource set associated with a common search space set are fully contained within a common frequency region and downlink control information format associated with the common search space set includes at least one of downlink control information formats defined for group-common physical downlink control channel.

37. The apparatus according to claim 36, wherein the downlink control information format comprises formats that are defined for scheduling multicast and/or broadcast traffic.

38. The apparatus according to claim 37, wherein the downlink control information format comprises formats 1_0 and/or 1_1.

39. The apparatus according to claim 36, wherein the instructions, when executed by the at least one processor, cause the apparatus to determine whether a search space index reservation has been configured.

40. The apparatus according to claim 30, wherein the instructions, when executed by the at least one processor, cause the apparatus to determine that the resource message indicates a monitoring priority rule indicative of application of a certain type and select the type of the monitoring priority rule based on determination whether at least one of downlink control information formats defined for group-common physical downlink control channel is configured.

41. An apparatus, comprising at least one processor and at least one memory storing instructions that, when executed by the at least one processor, cause the apparatus at least to:
send to a communication device on a control channel a resource message for configuring radio resource reception, the resource message indicating a first search space type and assistance information for the first search space type for enabling the communication device to determine that a second search space type is to be applied for monitoring of a multicast search space, and
multicast data to the communication device on the radio resource.

42. The apparatus according to claim 41, wherein the first search space type comprises a common search space type-3 and the second search space type comprises a common search space type for scheduling multicast/broadcast service.

43. The apparatus according to claim 41, wherein the resource message indicates the first search space type explicitly and the second search space type implicitly.

44. The apparatus according to claim 41, wherein the second search space type indicates monitoring priority.

45. The apparatus according to claim 41, wherein the resource message comprises a radio resource control message including information of control resource set resources associated with a common search space set.

46. A non-transitory computer readable media comprising program instructions that, when executed by an apparatus, cause the apparatus to perform at least the following:
receiving on a control channel a resource message indicating a first search space type and assistance information for the first search space type,
determining based on the assistance information that a second search space type is to be applied for monitoring of a multicast search space, and
monitoring the multicast search space according to the second search space type.

47. A non-transitory computer readable media comprising program instructions that, when executed by an apparatus, cause the apparatus to perform at least the following:
sending to a communication device on a control channel a resource message for configuring radio resource reception, the resource message indicating a first search space type and assistance information for the first search space type for enabling the communication device to determine that a second search space type is to be applied for monitoring of a multicast search space, and
multicasting data to the communication device on the radio resource.
